(19) United States
(12) Patent Application Publication
(10) Pub. No.: US 2008/0299163 A1
(43) Pub. Date: Dec. 4, 2008

(54) Anti-Fomitic Device Incorporating Anti-Microbial Metals

(76) Inventors: Marvin E. HASKIN, Bryn Mawr, PA (US); Jon L. Roberts, Great Falls, VA (US); Christopher B. Kilner, Oak Hill, VA (US)

Correspondence Address: ROBERTS, MARDULA & WERTHEIM, LLC, 11800 SUNRISE VALLEY DRIVE, SUITE 1000, RESTON, VA, 20191, US

(21) Appl. No.: 12/130,602

(22) Filed: May 30, 2008

Related U.S. Application Data
(60) Provisional application No. 60/941,506, filed on Jun. 1, 2007.

(51) Int. Cl. A01N 25/08; A01N 59/16; A01N 59/20; A01P 1/00

(52) U.S. Cl. 424/411; 424/409; 424/414; 424/618; 424/630; 424/641

(57) ABSTRACT

An anti-fomitic device in the form of a bag or envelope forms a cover for an object for preventing cross-infection by bacteria and other pathogens that may reside on the object. The anti-fomitic device is a flat, flexible bag or envelope with a closure mechanism at one or both ends of the bag or envelope, having a sterile interior that is sealed during manufacture to maintain sterility. Therefore, no outer wrapping for the anti-fomitic device is required. The anti-fomitic device is inverted when used to cover the object and results in an ultimate outer surface that is initially sterile. Materials for the coverings/bags serve as a barrier to the transmission of pathogens.

### CROSS-REFERENCE TO OTHER INVENTIONS

This application claims the benefit under 35 U.S.C. §119 of the filing date of Provisional Application No. 60/941,506 filed Jun. 1, 2007. The 60/941,506 application is incorporated by reference herein, in its entirety, for all purposes.

### BACKGROUND AND SUMMARY

The problems of cross-infection and the production of antibiotic-resistant mutations have been subjects for concern in hospital settings, as well as in household and other settings, such as the hospitality industry (hotels, motels, bed and breakfast businesses, hostels, etc.). These problems are particularly problematic for those with compromised immune systems or with special bacterial, viral fungal, parasitic, or other susceptibilities. The latter category of special susceptibilities may also include persons with allergies, and persons who develop one or more of a range of contact dermatitises, to name but a few non-limiting examples.

One way of transmitting bacteria, viruses, fungi, and other pathogens is by fomites, which are inanimate agents of such transmissions, including, for example, bedding, toilet seats, clothes, table tops and other fixed surfaces, surgical equipment, etc. Thus, a fomite (also called a fomes) may absorb or otherwise harbor one or more strains of pathogenic bacteria, fungi, viruses, etc., and later transmit those pathogens, by contact, to a human.

A common fomite is bedding, where commonly employed materials, such as cotton, act as wicks to carry pathogens far from the initial contact point with human skin, particularly when moisture is present (sweat, semen, saliva, vaginal secretions, secretions from wounds and open pimples, spilled drinks, etc.). Thus, when sheets and pillow cases are changed, the deeper lying material (mattress, mattress cover, pillow) still harbors potential pathogens of the previous user(s). Furthermore, the next user—particularly when moisture is introduced onto the “scene”—can become infected by reverse wicking; i.e., moisture can draw deep lying pathogens back toward the surface of the bedding that is in contact with the user.

Similar to bedding, clothing and related items (such as diapers, surgical robes and covers) also are subject to the problem of passing pathogens from the person wearing the item to another person or surface into which the item comes into contact. Again, as with bedding, the problem of cross-contamination is exacerbated by wicking in the presence of moisture.

Another common fomite is the surfaces encountered in bathrooms As has been well documented for decades, toilet seats, the faucet handles of wash basins, door handles, etc., and other surfaces in bathrooms are commonly contaminated with E. coli and other pathogens. As but one illustration of the problem, one need only recognize that a user of a toilet often will leave the toilet with substantial E. coli contamination of at least one hand. That individual may then, in turn, contaminate the knob/handle of the toilet stall, and then one or more faucet handles at a wash basin. Said individual then washes his hands, but touches the one or more faucet handles that he had just contaminated in the process of turning off the water flow, thereby re-contaminating his hand(s). Thus, whatever is subsequently touched by the E. coli-contaminated hand(s) of that individual will also become so contaminated.

As another example of cross-contamination in the bathroom setting, pathogens on toilet seats may be transmittable to the next user. One such example is the herpes viruses, which may be transmitted to a subsequent contactor, particularly if that individual has an open wound. Other pathogens may similarly be so transmitted, though some will require relatively immediate contact by the next person when the pathogen is not hardy outside a “biological” setting (i.e., a setting having the requisite moisture and/or temperature close to human interior body temperature).

Yet another setting that is ripe for cross-contamination is the kitchen. Not only is there the well documented potential problems with contamination sources such as chicken skin (Salmonella, etc.), raw beef (E. coli, etc.), and insects and other bugs and parts thereof (keeping in mind that the FDA allows such contamination to prescribed levels), but also E. coli contamination due to the use of toilets by the kitchen worker (or from contamination by a previous user of the toilet). In the same manner noted above in the context of bathrooms, cross-contamination of faucet handles of wash basins/sinks in kitchens is wide spread. The kitchen cross-contamination problem may also be extended to include problems from the use of cutting boards (problematic particularly with porous material like wood) and from inadequate cooking of contaminated food. In addition, inadequate cleaning of virtually all kitchen surfaces into which human skin comes into contact, directly or indirectly, further compounds the problem of cross-contamination; and this would include not only faucet handles, but also table, counter and other surfaces, as well as handles to ovens, refrigerators, microwave units, etc.

Still another fomite is computer devices where keyboards are used by multiple users in such settings as libraries, computer labs, retail stores and offices. In fact, the Centers for Disease Control traced one norovirus outbreak to computers in a school.

Cross-contamination may also occur during travel. On public transportation such as airplanes, travelers are often provided with complimentary travel pillows. These pillows may have been used by numerous other travelers. Despite changing the outer coverings, these pillows may still harbor pathogens spread by previous users. Similarly, headrests, armrests and cushions of airplane seats may also bear pathogens left by previous users.

U.S. Pat. Nos. 6,468,611 and 6,649,236 to Haskin disclose anti-fomitic devices in the form of a bag or envelope which forms a cover for an object for preventing cross-infection by bacteria and other pathogens that may reside on the object being covered. A sterile inner surface is inverted to form a sterile outer surface. While forming an anti-fomitic barrier when in use, these devices do not prevent future cross-infection from the newly-formed sterile outer surface or from the covered object after removal of the bag or envelope.

The anti-microbial properties of silver (silver ions) have been known for many years. The ancient Romans wrote of the healing powers of silver for treating wounds. More recently, silver nitrate and silver sulphadiazine have been employed topically for the treatment of burns due to the anti-microbial properties of silver. Similarly, silver-coated fibers have been used in surgical, burn, and wound dressings, such as those produced under the Silverlon® brand by Argentum Medical, LLC of Willowbrook, Ill. and the SilverSeal® brand by Noble Biomaterials, Inc. of Scranton, Pa. As such, the anti-microbial properties of silver have, thus far, primarily been used for wound dressings and such. Other metals with known anti-microbial properties include copper and zinc.

In the realm of medical and dental devices that come in direct contact with healthcare workers and patients, as well as in the realm of items common to the household and to the hospitality industry, a need exists for disposable covers that include a simple constellation of features not all available in any one or any combination of the above-cited disclosures. The covers should be simple in construction, and capable of easy and inexpensive production. The covers should be disposable. The covers should not permit the passage of bacteria and other disease causing organisms (pathogens) to pass from one side to the other. For example, organisms on a medical device should not be able to come in contact with a patient or healthcare worker, and, likewise, organisms on or in a patient or healthcare worker should not be able to penetrate the covers and thereby contaminate medical devices protected by the covers. Furthermore, the covers should have sufficient anti-microbial properties to kill a substantial portion of bacteria, fungi, and viri existing on the surface of the object covered and on the outer surface of the cover.

With respect to bedding and other applications (e.g., covers for equipment, faucet handles and other handles, etc.), the covers similarly should not permit the passage of pathogens from one side of the covers to the other. The covers preferably employ silver or the like (e.g., copper, zinc, etc.) in a manner sufficient to impart anti-microbial properties and should also be non-reactive with typical human skin so as not to produce irritation or contact dermatitis. The covers should be capable of easy and quick application for covering the desired object. Finally, the covers should be easily sealable or attachable, where applicable; and, where the application requires adhesive contact with human skin, the adhesive should not irritate the skin, or produce a contact dermatitis.

### BRIEF DESCRIPTION OF THE DRAWINGS

FIG. 1 illustrates a perspective view of a bag embodiment of a barrier for covering an object.

FIGS. 2A-2C illustrate close-up, cross-sectional embodiments of the barrier of FIG. 1.

FIG. 3 illustrates a perspective view of an embodiment with an “end pocket” at each end of a sheet that covers the front surface of an object.

FIG. 4 illustrates a cross sectional view along line 4-4 of FIG. 3.

FIG. 5 illustrates a perspective view of an embodiment in which a sheet of cover material and adhesive attachment mechanism are used to cover just the front and back surfaces of an object.

FIG. 6 illustrates a variation on the FIG. 5 embodiment in which the front of the object and the ends of the back are covered, with adhesive contacts being affected by the cover ends directly onto the back of the object.

FIG. 7 illustrates a perspective view showing sealing by heat sealing.

FIG. 8 illustrates a perspective view of an empty bag whose internal surfaces are sterile.

FIG. 9 illustrates a cross sectional view of the internally sterile bag of FIG. 8 folded back upon itself as an object is positioned therein by pressing against one end of the bag.

FIG. 10 illustrates the cross sectional view of FIG. 9 with an open end of the bag being advanced in a direction to unfold the bag, and to cover the uncovered end of the object positioned therein.

### DETAILED DESCRIPTION

Disclosed embodiments relate generally to a cover or barrier to prevent cross-infection. In particular, the embodiments relate to a range of anti-microbial anti-fomitic covers to both prevent cross-infection and disinfect surfaces, including such covers for pillows, mattresses, surgical and diagnostic equipment, toilet seats, table and chair seat surfaces, wash basin faucet handles and other handles, etc., as well as covers such as diapers or other similar sorts of “clothing,” for example, surgical robes, shoe covers for the surgical room, etc.

The embodiments disclosed achieve a variety of results and applications. As used herein, the term anti-microbial refers to the properties of being anti-bacterial, anti-fungal, and anti-viral.

In the following detailed descriptions, a flat object to be covered will be designated generally as A, and the cover therefor will be designated generally as B. In general, however, object A need not be flat. While illustrated as flat and prismatic, object A is not meant to be limited to such a shape and in other embodiments, A may represent any object that may be covered and that may come into contact with human skin or clothing, such as a pillow, a travel pillow, a mattress, a table, a chair, a headrest, an armrest, a toilet seat cover, a faucet handle, another type of handle and computer keyboards. Alternatively, A may be a body part (for example, a part covered by a diaper).

An embodiment provides a disposable, sealable bag or envelope structure that is silver-coated or silver-impregnated for encasing an object in a way that prevents the spread of bacteria and other pathogens among multiple persons using the same object and which further acts to kill bacteria, fungi, and viri that are on the object and/or come in contact with the sealable bag or envelope structure. The object to be covered by the bag or envelope structure can be virtually any medical, surgical or diagnostic equipment or part thereof, particularly an item or part that may come into contact with human skin or clothing, such as, for example and not as a limitation, a medical device, a surgical instrument or other diagnostic instrument, a bedding, table or chair seat surface, a faucet handle, another type of handle, or computer keyboards. In addition, the object to be covered by the bag or envelope structure may be any other object that may be covered and that may come into contact with human skin or clothing, whether in a medical setting or not, such as, for example and not as a limitation, a pillow, a travel pillow, a mattress, a table, a chair, a cushion, a headrest, an armrest, a toilet seat cover, a faucet handle or other handle, or a computer keyboard. The object to be covered may also be a body part (for example, a part covered by a diaper). Collectively, the group of objects which may be covered may be referred to as “enclosed object(s)”.

The enclosed objects may be found in various settings where multiple persons may come in contact with them. As an example, and not as a limitation, the enclosed objects may be in a home, in a school, in a hospital or medical clinic, in an office, in a hotel, or on a public transportation vehicle such as a bus, train or airplane.

In a further embodiment, the bag or envelope structure which covers the enclosed object may be made of any disposable material capable of carrying anti-microbial silver (or similar metal) compounds that is suitable for contact with human skin, and that also provides a barrier to at least bacteria and other pathogens of a similar size. Further, the barrier comprising disposable material will prevent smaller pathogens (for example, viruses) from reaching a user. These materials should be capable of carrying an amount of anti-microbial compounds that is sufficient to impart anti-microbial properties to the cover. The anti-microbial compounds may be applied to the surface or impregnated into the material of the cover using any suitable method.

In another embodiment, the anti-microbial compounds carried by the cover can include, but are not limited to: silver, copper or zinc deposited by chemical or physical vapor deposition onto one or both surfaces of the barrier material; a coating containing nanoparticles of silver, copper or zinc on one or both surfaces of the barrier material; and various salts of silver, copper or zinc bound to one or both surfaces of the barrier material. Suitable compounds provide sufficient ions of silver, copper, or zinc to cause the anti-microbial effect.

Silver-coated polymeric fibers, such as X-Static (fiber from Noble Biomaterials, can be embedded in the barrier material or adhered to the surface thereof. A coating containing anti-microbial silver nanoparticles may also be applied to the barrier. For paper barrier materials, a known silver-based anti-microbial compound is disclosed in U.S. Pat. No. 5,709,870. For polymer barriers, a known silver-based anti-microbial compound is disclosed in U.S. Pat. No. 6,716,895. Similarly, a coating containing anti-microbial silver nanoparticles is disclosed in U.S. Pat. No. 6,822,034.

In a further embodiment, the bag or envelope structure which covers the enclosed object may be made of any suitable materials including, but not limited to, paper; non-woven cellulosic derivatives, including any of the huge array of plastics suitable for use against human skin, such as polyvinyl chloride (including homopolymers and copolymers thereof), polyesters, polyolefins, and other polymers; and paper coated with plastic, which plastic may be one of the plastics previously listed. Another embodiment employs paper or plastics in the barrier that is biodegradable.

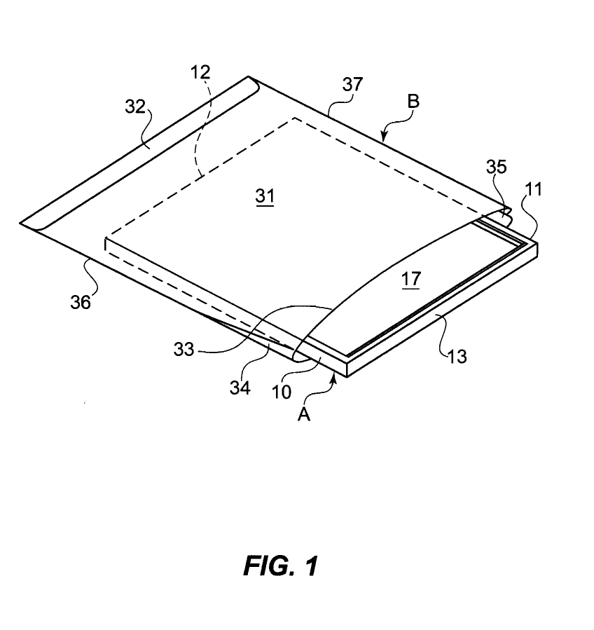

Referring to FIG. 1, A is featured as a prismatic object with sides 10 and 11, and ends 12 and 13. Object A includes a front surface (not shown) that typically might contact a patient's skin, and a back 17.

The cover B of FIG. 1 has the form of a bag or envelope with a front (not shown), back 31, sealed end edge 32, and opening 33. Object A is inserted into opening 33 until it is completely covered.

Another embodiment provides multiple, optional, closure/sealing mechanisms for a disposable bag or envelope structure that is silver-coated or silver-impregnated for encasing a surgical instrument or diagnostic instrument, bedding, table or chair seat surface, faucet handle or other handle, a computer keyboard, etc. The sealing mechanisms may include, but are not limited to, adhesives (including, for example, pressure-sensitive adhesives and adhesive strips that are covered with a protective sheet or strip when not in use), heat sealing, hook-and-loop structures (for example, Velcro®), zippers, zip-lock fasteners and tucked flaps.

Referring again to FIG. 1, any of the above listed closure mechanisms may be used to seal opening 33.

Referring to FIG. 7, a heat sealable plastic cover/bag B that is coated or impregnated with an anti-microbial silver compound encloses object A, and end 51 is closed by conventional heat sealing, for example with an impulse sealer or an electrically heated anvil 52, combined with companion anvil 53. In addition, with suitable plastic, the cover can be heat shrunk about the object by subjecting the cover to a short blast of hot air.

A further embodiment provides a disposable, sealable flat bag that is silver-coated or silver-impregnated for encasing an enclosed object, where the edges of the bag incorporate pleats or slits to facilitate the introduction, positioning and enclosure of a range of objects therein.

Referring again to FIG. 1, edges 36 and 37 of the cover B can optionally include pleats 34 and 35 to facilitate covering objects of greater depth.

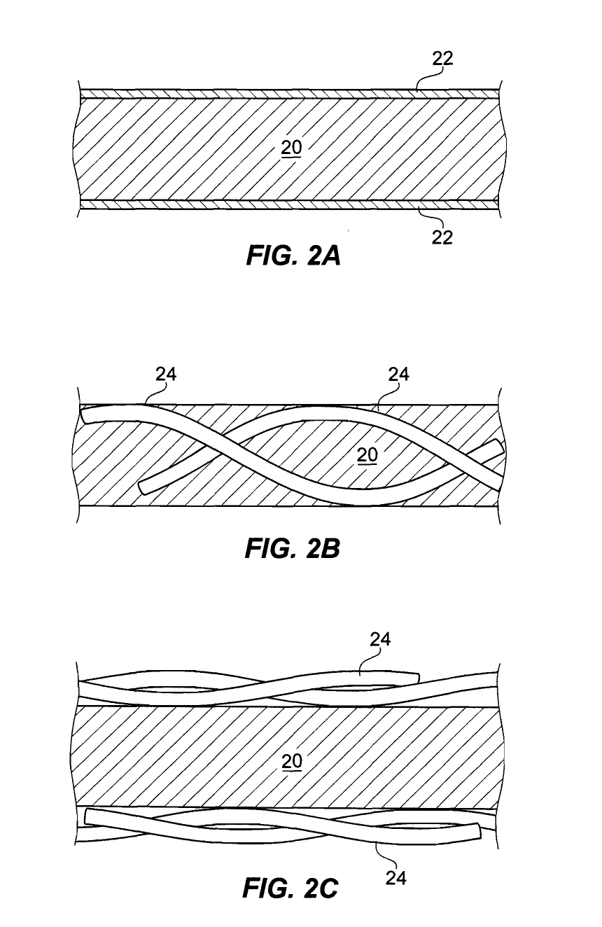

FIGS. 2A, 2B, and 2C disclose close-up cross-sectional views of typical embodiments of the barrier of the cover B. FIG. 2A illustrates an embodiment of a barrier material that comprises a polymeric layer 20 that serves as a barrier to pathogens and that has anti-microbial compounds 22 of the present invention adhered to at least one surface thereof (and to both surfaces in the illustrated embodiment). While illustrated as layers, the adhered anti-microbial compounds 22 are not limited to uniform coatings, and may also include non-uniform dispersions of material.

FIG. 2B illustrates another embodiment of a barrier material in which a polymeric layer 20 that serves as a barrier to pathogens is impregnated with fibers 24 coated or formed with anti-microbial compounds of the present invention.

FIG. 2C illustrates an embodiment of a barrier material in which a polymeric layer 20 that serves as a barrier to pathogens has fibers 24 coated or formed with anti-microbial compounds of the present invention adhered to at least one surface thereof (and to both surfaces in the illustrated embodiment).

Yet another embodiment provides a disposable bag that is silver-coated or silver-impregnated for covering the front of an object or device such as a surgical or diagnostic instrument by providing “end pockets” at each end of a flat sheet. Thus, the front surface of the object is covered, as well as the back surface at each end to the extent of the depth of the two “end pockets.”

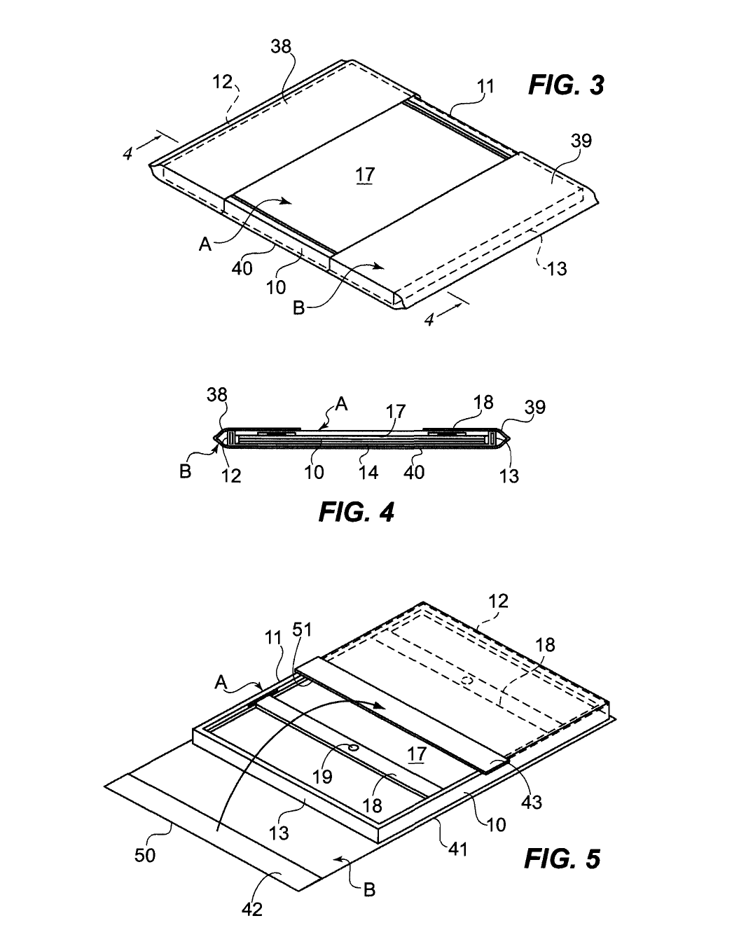

Referring to FIGS. 3 and 4, cover B is shown to comprise end pockets 38 and 39 and an intermediate portion 40 that covers the front surface 14 of the object. This embodiment is used by inserting object end 13 into end pocket 39, and object end 12 into end pocket 38. FIG. 4 represents the cross sectional view along line 4-4 of FIG. 3.

Another embodiment is a disposable flat sheet formed of silver-coated or silver-impregnated material with a fastening mechanism on one surface at each end, such that the object to be covered by the sheet (for example, a table or chair seat surface, etc.) is placed face down on the sheet (or vice versa) and the two ends are folded around the object such the adhesive ends of the sheet overlap and may be fastened securely to each other, thus enclosing the object snugly in the sheet.

Referring to FIG. 5, cover B is shown as a single sheet 41 having ends 50 and 51. The inside of end 50 is provided with a coating of pressure-sensitive adhesive 42. The outside of end 51 is also provided with pressure-sensitive adhesive 43. The length of sheet 41 is sufficient to permit mutual contact of the entire widths of adhesive strips 42 and 43 when the sheet is wrapped around the object to be covered. Any of the other closure mechanisms enumerated above may also be used.

Yet another embodiment provides a disposable flat sheet that is silver-coated or silver-impregnated for covering the front of an enclosed object by merely folding ends over to attach by adhesive to the back of the object.

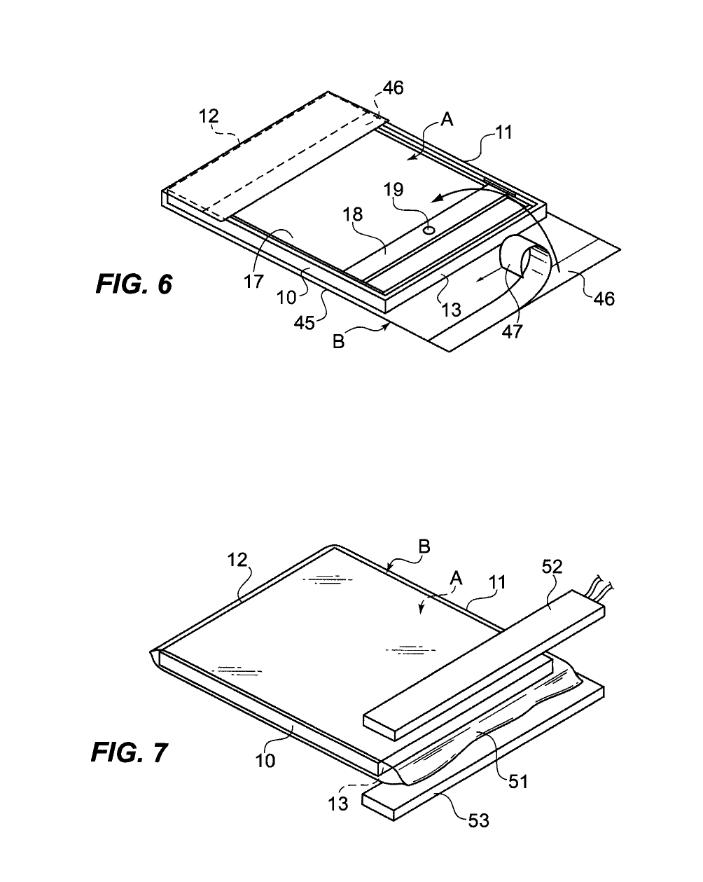

Referring to FIG. 6, cover B is shown as a single sheet 45 that is coated with pressure-sensitive adhesive 46 at both ends, including a protective strip 47 that is removed by peeling just prior to application. In use, object A is positioned face down on the cover, protective strips 47 are removed, and the ends are wrapped around to the back, where the pressure-sensitive adhesive strips 46 engage the back 17 and optionally also sides 10 and 11 of the object.

Another embodiment uses a silver-coated or silver-impregnated bag folded back upon itself (prior to use) such that, once the object to be covered is inserted into the bag (and thereby is partially covered to the depth of that portion of the bag), the folded-over section is pulled over the remaining portion of the object, and closure is effected. Hence, the previously internal, sterile, folded-over bag surfaces become the external surfaces against which the skin of a person comes in contact, thereby providing the advantage of a potentially totally clean and initially sterile outer covering. Such back-folded bags are intended for a broad range of applications, and may be used, for example but not as a limitation, for coverage of any of the group of enclosed objects described above.

Referring to FIGS. 8, 9 and 10, which are related, it is shown how a cover surface that will contact a patient can be kept sterile until shortly before use. A plastic bag B has ends 55 and 56, a front 59, and a rear 60. Either or both ends 55 and 56 are sealed in such a manner that, while air-tight, they can be readily opened. This can be achieved by tack sealing or incorporation of a tear strip for the opening of a conventional heat seal. The remaining edges are sealed in any conventional air-tight permanent manner. The bag is prepared under sterile conditions such that at least the interior is sterile at time of use. In addition, end-to-end such bags may be prepared and stored on rolls, with appropriate scoring or perforations between the bags.

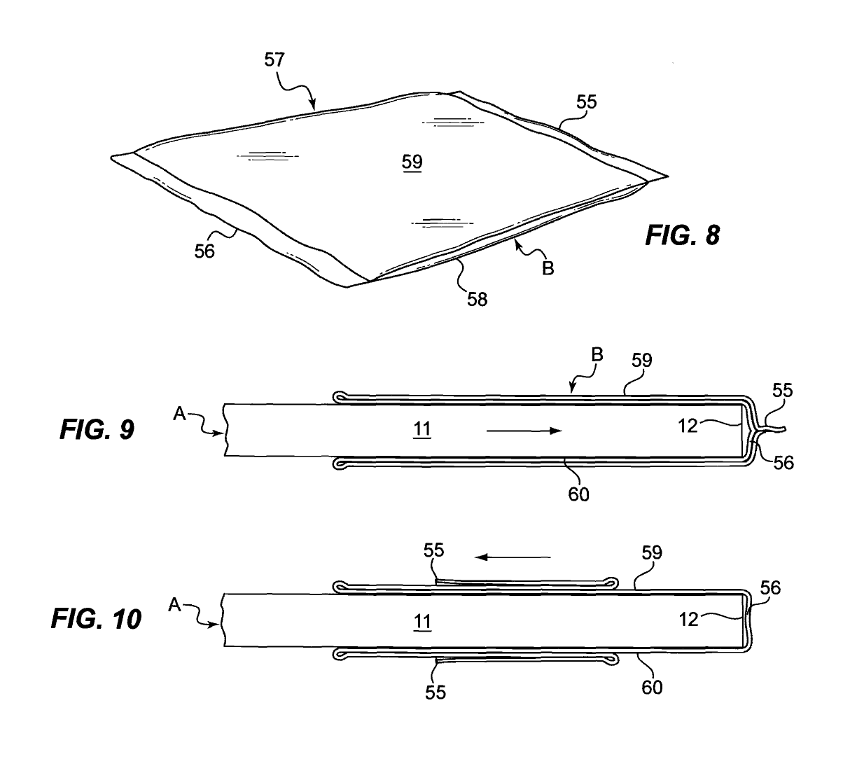

Referring to FIGS. 8 and 9, enclosed object A is pressed against one end of bag B, for example end 56, and forced in such a manner that the bag doubles back on itself to the point that end 56 abuts against end 55, and edge 12 of the enclosed object is flush against end 56. This operation may be aided by a sleeve-like jig (not shown) that fits around the object. Thereafter, sealed end 55 is opened fully, and the bag is peeled back on itself, as is shown in FIG. 10. Thus, the previously sterile inside surfaces of the bag are now on the outside of the bag, ready for engagement with the skin of a patient and free of bacteria and pathogens that may lurk on the surfaces of the object.

The inside-out principle demonstrated in FIGS. 8-10 may be applied to any of the group of enclosed objects previously described.

An additional benefit of the inside-out principle of FIGS. 8-10 is that bacteria and other pathogens on the skin of a person handling the enclosed object may thereby be eliminated from the cross-contamination cycle that otherwise would prevail in the clinical setting using conventional practices.

Another embodiment provides a disposable bag structure that is silver-coated or silver-impregnated for covering an enclosed object, where the disposable bag structure is part of a continuous structure of end-to-end bags that may be stored in rolled form, and with perforations or other scoring between adjacent bags to facilitate their separation when ready for use.

In each embodiment described herein, anti-microbial ions of silver, copper, or zinc from the cover act on the object being covered to kill bacteria, fungi and viri near the surface of the object.

Though the anti-microbial anti-fomitic covers of the present invention are directed mainly to various medical, surgical and diagnostic apparatuses and computer keyboards, they also apply to such areas as pillows and mattresses, travel pillows, faucet handles and other handles, table and chair seat surfaces, headrests, armrests, toilet seats, etc. Thus, by using the back-folded bag embodiments or disposably-removable plurality of covers embodiments, a pillow cover, for example, may be made that permits a hospital patient to experience a totally clean surface on which to place his head or other body part. Alternatively, one or more of the embodiments may be used to provide a clean pillow cover for a pillow received and used during an airline flight or hotel stay.

Although described herein with reference to particular embodiments, one of ordinary skill in the art will recognize that numerous additional embodiments are possible and that various modifications can be made without departing from the scope of the present invention, which is limited only by the claims below. For example, the above embodiments have emphasized use with a generic object, and in one embodiment use with pillows, mattress covers, table covers, etc. However, it is to be understood that the general concepts may be applied to a broad range of surgical or diagnostic equipment, as well as numerous domestic and household applications not specifically enumerated herein. Thus, it is intended that the specific embodiments presented herein are not limiting as to scope, but, rather, detail specific embodiments that may be generalized to a larger constellation of potential applications. Further, any reference to claim elements in the singular, for example, using the articles “a,” “an,” or “the” is not to be construed as limiting the element to the singular.

What is claimed is:

1. An anti-microbial anti-fomitic device for covering an object, comprising:
a barrier sized to cover a surface of an object, the barrier having an interior surface for facing the object and an exterior surface, the barrier comprising:
a material that serves as a barrier to pathogens, and
an anti-microbial compound impregnated in the barrier or coated on at least one of the interior surface and exterior surface of the barrier, the anti-microbial compound containing ions selected from the group consisting of silver, copper, and zinc in a large enough amount to produce an anti-microbial effect.

2. The anti-microbial anti-fomitic device according to claim 1, where the material that acts a barrier to pathogens is a plastic selected from the group consisting of polyvinyl chloride, homopolymers of polyvinyl chloride, copolymers of polyvinyl chloride, polyesters, polyethylenes, polypropylenes, and polyolefins.

3. The anti-microbial anti-fomitic device according to claim 2, where the plastic is biodegradable.

4. The anti-microbial anti-fomitic device according to claim 1, where the material that serves as a barrier to pathogens is paper.

5. The anti-microbial anti-fomitic device according to claim 1, where the material that serves as a barrier to pathogens is paper, coated with a plastic selected from the group consisting of polyvinyl chloride, homopolymers of polyvinyl chloride, copolymers of polyvinyl chloride, polyesters, polyethylenes, polypropylenes, and polyolefins.

6. The anti-microbial anti-fomitic device according to claim 5, where the plastic is biodegradable.

7. The anti-microbial anti-fomitic device according to claim 1, wherein the barrier is a bag; the bag comprising a closed end and a removably sealed open end.

8. The anti-microbial anti-fomitic device according to claim 7, where the removably sealed open end further comprises a closure mechanism

9. The anti-microbial anti-fomitic device according to claim 8, where the closure mechanism is selected from the group consisting of heat sealing, pressure-sensitive adhesive, zipper, zip-lock fastener, tucked flap, and hook-and-loop.

10. The anti-microbial anti-fomitic device according to claim 9, where the pressure-sensitive adhesive is protected with a strip of a material until the pressure-sensitive adhesive is needed.

11. The anti-microbial anti-fomitic device according to claim 10, where the strip is a material selected from the group consisting of paper and plastic.

12. The anti-microbial anti-fomitic device according to claim 7, wherein the bag further comprises a sterile interior surface, wherein, said bag is initially air-tight and when the removably sealed open end is opened, the bag is turned inside out to cover said object, resulting in the sterile interior being on the outside.

13. The anti-microbial anti-fomitic device according to claim 7 further comprising said bag being dimensioned so as to enable covering of said object where the object is a member selected from the group consisting of surgical devices, surgical instruments, diagnostic equipment, pillows, mattresses, faucet handles, toilet seats, table tops, and chair seats.

14. The anti-microbial anti-fomitic device according to claim 7, further comprising said bag and said removably sealed open end of said bag being dimensioned so as to enable covering of said object when said object comprises bedding.

15. The anti-microbial anti-fomitic device according to claim 14, wherein said bedding is selected from the group consisting of pillows and mattresses.

16. The anti-microbial anti-fomitic device according to claim 7, further comprising said bag and said removably sealed open end of said bag being dimensioned so as to cover a pillow.

17. The anti-microbial anti-fomitic device according to claim 7, further comprising said bag and said removably sealed open end of said bag being dimensioned so as to cover a mattress.

18. The anti-microbial anti-fomitic device according to claim 1, wherein the barrier is a sheet of material sized to wrap around the object.

19. The anti-microbial anti-fomitic device according to claim 1, wherein the barrier is a rectangular sheet having object-engaging pockets at opposite ends thereof.

20. An anti-microbial anti-fomitic bag, comprising:
a closed bag which is initially air-tight and serves as a barrier to pathogens, said bag comprising an exterior surface and a sterile interior surface;
an anti-microbial compound containing ions selected from the group consisting of silver, copper, and zinc;
an opening; and
a sealed resealable closure for said opening, wherein the resealable closure is initially air-tight and adapted to be resealed after the resealable closure is opened and the bag inverted.

21. The anti-microbial anti-fomitic bag of claim 20, wherein the anti-microbial compound is impregnated in the bag.

22. The anti-microbial anti-fomitic bag of claim 20, wherein the anti-microbial compound is coated on at least one of the interior surface and exterior surface of the bag.
